(19) United States
(12) Patent Application Publication
(10) Pub. No.: US 2015/0200465 A1
(43) Pub. Date: Jul. 16, 2015

(54) EQUAL INTERVAL MULTIPATH REJECTED ANTENNA ARRAY

(71) Applicant: Honeywell International Inc., Morristown, NJ (US)

(72) Inventors: Nan Wang, Shang Hai (CN); Orville Nyhus, Glendale, AZ (US)

(73) Assignee: Honeywell International Inc., Morristown, NJ (US)

(21) Appl. No.: 14/156,576

(22) Filed: Jan. 16, 2014

(51) Int. Cl. H01Q 21/12; H01Q 9/16

(52) U.S. Cl. CPC H01Q 21/12; H01Q 9/16

(57) ABSTRACT

Systems and methods for an equal interval multipath rejecting antenna array are provided. In one embodiment, and antenna system comprises: a plurality of dipole elements equally spaced along a linear central antenna mast, the plurality of vertically orient dipole elements spaced apart by λ/2 along the central antenna mast and oriented normal to the central antenna mast; and a feed network to drive each of said elements. Each of the plurality of dipole elements is actively fed by the feed network and wherein there are no non-fed parasitic elements between any two of the plurality of dipole elements.

### BACKGROUND

Differential GPS systems enhance the capability of a Global Positioning System to provide much-improved accuracy from meters to centimeters. The ground-based reference station is involved in a Differential GPS (D-GPS) system to broadcast the pseudorange difference between the location indicated by GPS satellite signal processing and the known fixed location of the reference station. A GPS receiver may then use the broadcast data to correct its pseudorange by the same amount. The positioning accuracy of a GPS system is affected by various factors. One important factor is that the received antenna should, ideally, receive only the direct path GPS signal and filter out all undesired signals most of which are contributed by ground reflected interference. The choke-ring antenna is widely utilized in GPS systems to block reflected-GPS signals for general purposes, such kind of antennas are able to provide suppression of about −20 dB. The polarization of a direct GPS signal is right hand circular (RHCP). When a GPS signal transmitted from a satellite having an elevation angle above the Brewser angle is reflected off a horizontal surface as the ground, it will exhibit left hand circular polarization (LHCP) due to a 180 degree phase shift induced by reflection. Unfortunately, 20 dB suppression is not always acceptable for each scenario. For example, the D-GPS system generally requires better suppression of back/side lobes of about 30 dB to both the RHCP and LHCP gain patterns.

For the reasons stated above and for other reasons stated below which will become apparent to those skilled in the art upon reading and understanding the specification, there is a need in the art for improved GPS antenna designs.

### SUMMARY

The Embodiments of the present invention provide for improved GPS antenna designs and will be understood by reading and studying the following specification.

Systems and methods for an equal interval multipath rejecting antenna array are provided. In one embodiment, and antenna system comprises: a plurality of dipole elements equally spaced along a linear central antenna mast, the plurality of vertically orient dipole elements spaced apart by λ/2 along the central antenna mast and oriented normal to the central antenna mast; and a feed network to drive each of said elements. Each of the plurality of dipole elements is actively fed by the feed network and wherein there are no non-fed parasitic elements between any two of the plurality of dipole elements.

### DRAWINGS

Embodiments of the present invention can be more easily understood and further advantages and uses thereof more readily apparent, when considered in view of the description of the preferred embodiments and the following figures in which:

FIG. 1 illustrates an antenna system in accordance with one embodiment of the present disclosure;

FIG. 2 presents a graph illustrating the antenna pattern of a linear array antenna of one embodiment of the present disclosure;

FIG. 3 presents a graph illustrating the antenna pattern of a linear array antenna of one embodiment of the present disclosure; and

FIG. 4 is a flow chart illustrating a method of one embodiment of the present invention.

In accordance with common practice, the various described features are not drawn to scale but are drawn to emphasize features relevant to the present invention. Reference characters denote like elements throughout figures and text.

### DETAILED DESCRIPTION

In the following detailed description, reference is made to the accompanying drawings that form a part hereof, and in which is shown by way of specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

Embodiments presented in this disclosure provide a novel linear antenna array in which the spacing between each adjacent element is equal and in which every element is an actively fed element. As will be described below, because every element is fed, linear antenna array designs described herein can provide for antenna designs that include a greater number of elements in within physically more compact dimensions than those that include non-fed or parasitic antenna elements. Further, the superior roll-off of signal power for signals arriving from elevation angles below those of the horizon (i.e., elevation angles greater than 0 degrees, or at an angle of greater than 90 degrees as measured from Zenith). It should be appreciated that the angle from Zenith is the complement of the elevation angle, which is the angle between the path of signal propagation and the horizon.

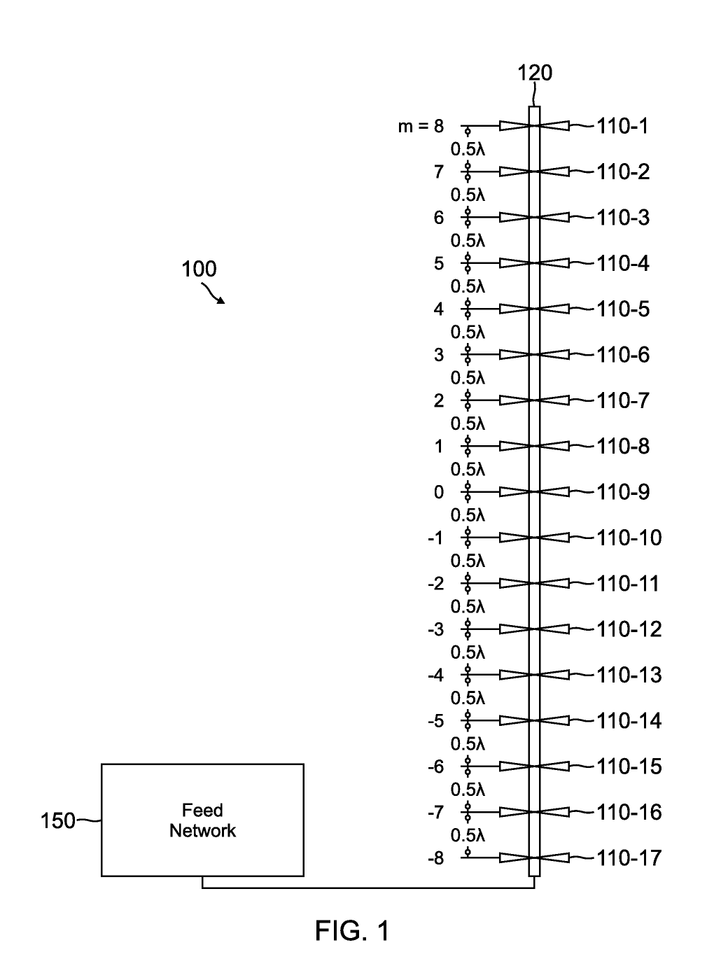

FIG. 1 is a diagram illustrating a linear antenna array of one embodiment of the present disclosure shown generally at 100. Linear antenna array 100 comprises 17 elements 110-1 to 110-17, occupying respective antenna correspond respectively to antenna bays m=−8, −7, −6, −5, −4, −3, −2, −1, 0, 1, 2, 3, 4, 5, 6, 7, 8. Each of the elements 110-1 to 110-17 are dipole antenna elements. Elements 110-1 to 110-17 are evenly distributed along a linear central antenna mast 120 at a spacing of λ/2 from it neighboring element. As used herein, λ represents the incoming signal wavelength and may also be thought of as the radio wavelength to which the antenna is tune for. For example, any of the linear antenna arrays described herein may be tuned for use in receiving radio signals for wavelengths used in GPS and/or D-GPS systems. Mast 120 is oriented substantially normal to the horizon such that elements 110-1 to 110-17 are vertically oriented, normal to mast 120. The orientation of the elements 110-1 to 110-17 provides a linear array pattern covering the upper hemisphere with a sharp cut-off at a relatively small angle above the horizon.

Although, FIG. 1 illustrates a 17 element design, one of ordinary skill in the art who has studied this disclosure would appreciate that other embodiments of the present disclosure may include a fewer or greater number of elements without departing from the teachings of this disclosure. The 17 element design of linear array antenna 100 can accomplish more than 40 dB suppression of signals arriving from elevation angles below those of the horizon.

Theoretically, suppose the spacing between antenna array elements is

$$= γ \frac{λ}{2} ,$$

for an odd elements linear antenna array, the synthetic field could be given by:

$${E}_{n sum} ( α ) = \vert {E}_{n sum} ( α ) \vert cos ( n γπ sin ( α ) - {β}_{n} )$$

$$where$$

$$\vert {E}_{n sum} ( α ) \vert = \vert \frac{2}{n π} sin [ \frac{n γπ}{2} ( sin ( {α}_{2} ) - sin ( {α}_{1} ) ) ] \vert$$

$$and$$

$${β}_{n} = \frac{n γπ}{2} [ \begin{matrix}sin ( {α}_{2} ) + \\ sin ( {α}_{1} )\end{matrix} ] + \frac{π}{2} \{ 1 - sin [ \frac{2}{n π} sin [ \frac{n γπ}{2} ( \begin{matrix}sin ( {α}_{2} ) - \\ sin ( {α}_{1} )\end{matrix} ) ] ] \}$$

where application of the sign function accounts for negative values of the amplitude of E_{n sum} (α), i.e., the phase is adjusted 180 degrees if the amplitude is negative.

Finally,

AF(α)=E₀(α)+Σₙ₌₁^{N}E_{n sum(α)}

This configuration produces circular polarization in the two directions perpendicular to the plane of the elements (that is, upward and downwards for horizontal dipole elements). However, the axial ratio in such systems degrades in directions away from the perpendicular axis and becomes linearly polarized in the plane of the dipole elements.

As mentioned above, embodiments of the present disclosure present a linear antenna array where each of the elements of the antenna are fed without the presence of intervening parasitic elements separating any two of the elements. As such, each of the elements 110-1 to 110-17 are driven by a feed network 150 configured to drive each of the elements. The individual elements 110-1 to 110-17 are driven at specific amplitudes and phases to achieve suitable cancellation of signals below the threshold angle from Zenith of 90 degrees. Feed network 150 therefore includes such signal couplers and other standard components as would be know to those of ordinary skill in the art. For the embodiment of FIG. 1, Feed network 150 is configured according to the teachings of the present application to establish the correct amplitudes and phase delays at each of the elements 110-1 to 110-17. For example, in one embodiment, feed network 150 includes a quadrature feed for implementations where elements 110-1 to 110-17 comprise crossed inverted-vee dipoles. For further background, there are various techniques used by those of skill in the art for adjusting the resultant antenna radiation pattern such as described in U.S. Pat. No. 6,452,562, which is incorporated herein by reference in its entirety.

As previously stated, each of the elements 110-1 to 110-17 of antenna 100 comprises an element that is actively fed by network 150, each of the elements 110-1 to 110-17 are equally spaced at a distance of λ/2 and there are no non-fed parasitic elements present between any two of the elements 110-1 to 110-17. It should be appreciated that the ultimate antenna pattern for linear antenna array 100 will be a function of an array factor multiplied by the antenna pattern of the individual elements 110-1 to 110-17. In one embodiment, elements 110-1 to 110-17 are driven as shown in Table 1. As observable from table 1, in such an embodiment, the center element (m=0) is driven at 0 db and at a phase angle of 0 degrees; even numbered elements (m=±2, ±4 and ±6 are also driven at a phase angle of 0 degrees; and the two terminating elements 110-1 and 110-17 are driven at +180 degrees and −180 degrees, respectively. Then, the remaining positive m elements at m=1, 3, 5 and 7 are driven to a phase angle of −90 degrees while the remaining negative m elements at m=−1, −3, −5 and −7 are driven to a phase angle of +90 degrees.

TABLE 1

| Element | Amplitude (dB) | Phase (deg) | m |
|---|---|---|---|
| | — | — | — |
| 110-1 | −32.4 | (+/−)180 | 8 |
| 110-2 | −24.16 | −90 | 7 |
| 110-3 | −38.82 | 0 | 6 |
| 110-4 | −20.48 | −90 | 5 |
| 110-5 | −34.6 | 0 | 4 |
| 110-6 | −14.68 | −90 | 3 |
| 110-7 | −30.71 | 0 | 2 |
| 110-8 | −4.39 | −90 | 1 |
| 110-9 | 0 | 0 | 0 |
| 110-10 | −4.22 | 90 | −1 |
| 110-11 | −30.32 | 0 | −2 |
| 110-12 | −14.22 | 90 | −3 |
| 110-13 | −34 | 0 | −4 |
| 110-14 | −20.05 | 90 | −5 |
| 110-15 | −35.17 | 0 | −6 |
| 110-16 | −23.58 | 90 | −7 |
| 110-17 | −35 | (+/−)180 | −8 |
| | — | — | — |

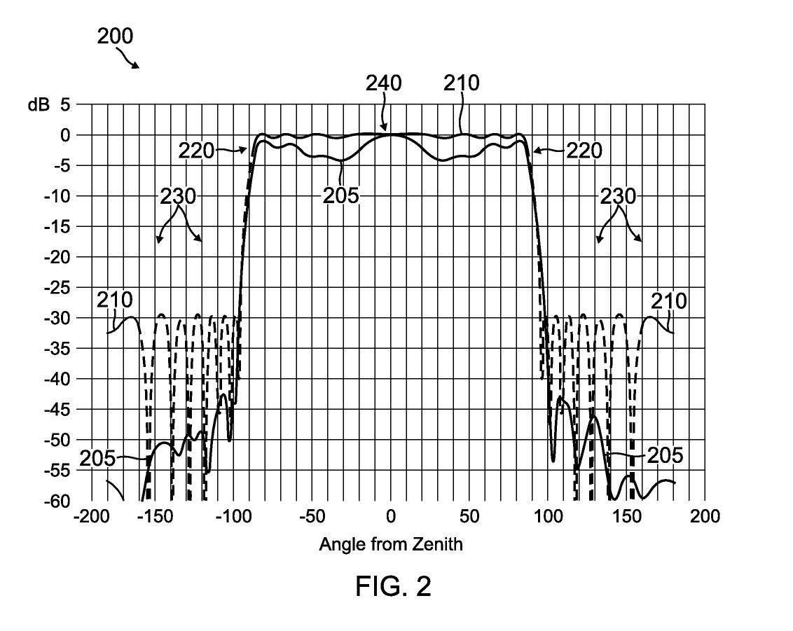

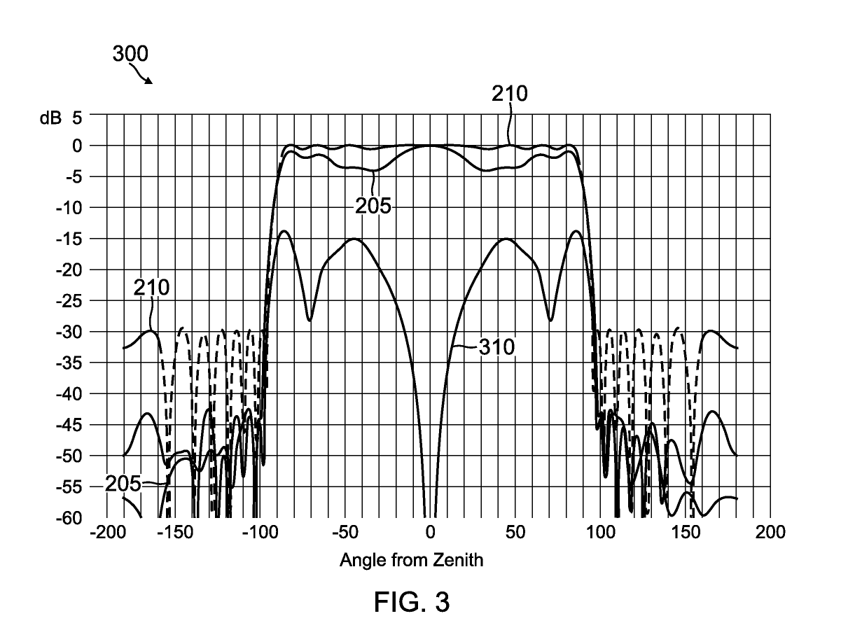

For the 17 element antenna 100 described above and driven as shown if Table 1, FIG. 2 illustrates (as shown by pattern 205) the improved roll-off in received signal gain at angles from Zenith beyond 90 degrees, as compared to a pattern (as shown at pattern 210) for a prior art 11 element linear array antenna having parasitic elements between active elements. As is evident from FIG. 2, below the horizon all sidelobes (shown at 230) are indicated to be greater than −30 dB down from the signal gain at the horizon (shown at 220) with greater signal rejection obtained as the angle from zenith (as shown at 240) increases. Also as evident from FIG. 3, substantial rejection of LHCP waveforms (shown at 310) by at least −15 dB is obtained for signals received from above the horizon (i.e., angles from Zenith of −90 degrees to 90 degrees). In one embodiment, each element 110-1 to 110-17 is substantially isotropic. Ideally, it is desirable to use elements as nearly isotropic as possible, however, in practice, a truly isotropic radiation pattern is generally rare. With antenna 100 fed as described by table 1, the antenna polarization is right-hand circular polarization (RHCP) and the individual elements will radiate (and receive) RHCP electromagnetic signals.

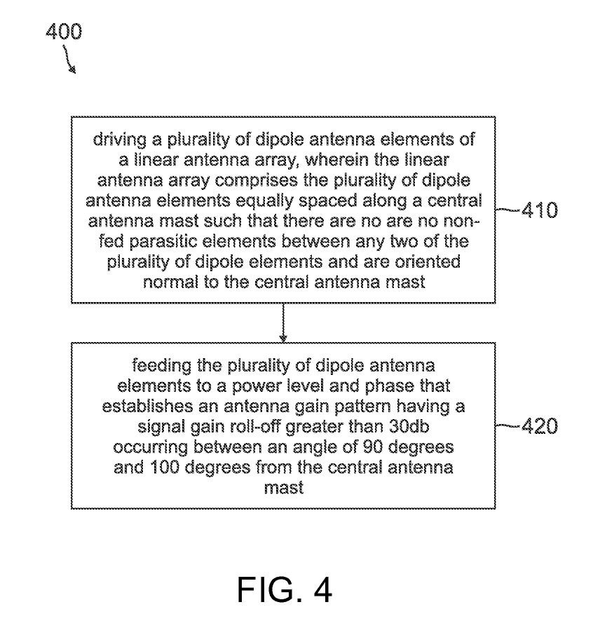

A corresponding method 400 incorporating the embodiments described above is illustrated in the flow chart of FIG. 4. The method begins at 410 with driving a plurality of dipole antenna elements of a linear antenna array. The linear antenna array comprises the plurality of dipole antenna elements, which are equally spaced along a central antenna mast. As explained above, all of the elements are feed such that there are no are no non-fed parasitic elements between any two of the plurality of dipole elements. The elements are also oriented normal to the central antenna mast. In one implementation, the central antenna mast is supported into a position that is normal to the Earth's horizon such that the dipole antenna elements are each vertically oriented. In one such an implementation, one terminating end of the central antenna mast would thus be pointed towards the sky's Zenith. The method the proceeds to 420 with feeding the plurality of dipole antenna elements to a power level and phase that establishes an antenna gain pattern having a signal gain roll-off greater than 30 db. As shown in FIGS. 2 and 3, with the elements driven in accordance with the various elements described above in paragraph [0018] and Table 1, a signal gain roll-off occurring between an angle of 90 degrees and 100 degrees from Zenith can be achieved.

### EXAMPLE EMBODIMENTS

Example 1 includes an antenna system, the system comprising: a plurality of dipole elements equally spaced along a linear central antenna mast, the plurality of vertically orient dipole elements spaced apart by λ/2 along the central antenna mast and oriented normal to the central antenna mast; and a feed network to drive each of said elements; wherein each of the plurality of dipole elements is actively fed by the feed network and wherein there are no non-fed parasitic elements between any two of the plurality of dipole elements.

Example 2 includes the system of Example 1 wherein the central antenna mast is oriented substantially normal to the horizon such that the plurality of dipole elements are vertically oriented.

Example 3 includes the system of any of Examples 1-2, wherein the plurality of dipole elements are driven by the feed network to establish a power level and phase to produce an antenna pattern having a signal gain roll-off greater than 30 db occurring between an angle of 90 degrees and 100 degrees from the central antenna mast.

Example 4 includes the system of any of Examples 1-3, wherein the plurality of dipole elements are driven by the feed network such that a dipole element positioned at a center bay along the central antenna mast is driven at 0 db and at a phase angle of 0 degrees, and terminating dipole elements on the central antenna mast are driven at ±180 degrees.

Example 5 includes the system of Example 4, wherein dipole elements positioned at even numbered bays along the central antenna mast between the center bay and the terminating dipole element are also driven at a phase angle of 0 degrees.

Example 6 includes the system of any of Examples 4-5, wherein dipole elements positioned at odd numbered bays along the central antenna extending from a first side of the center bay are driven to a phase angle of −90 degrees while dipole elements positioned at odd numbered bays along the central antenna extending from a second side of the center bay are driven to a phase angle of +90 degrees.

Example 7 includes the system of any of Examples 1-6, wherein the plurality of dipole elements comprises a total of seventeen dipole elements.

Example 8 includes the system of Example 7, wherein the seventeen dipole elements are positioned along the central antenna mast in respective antenna bays m=8 to m=−8 and are driven by the feed network to establish a power level and phase in accordance with:

| Power Level | Phase | Bay |
|---|---|---|
| (dB) | (degrees) | (m) |
| −32.4 | (+/−)180 | 8 |
| −24.16 | −90 | 7 |
| −38.82 | 0 | 6 |
| −20.48 | −90 | 5 |
| −34.6 | 0 | 4 |
| −14.68 | −90 | 3 |
| −30.71 | 0 | 2 |
| −4.39 | −90 | 1 |
| 0 | 0 | 0 |
| −4.22 | 90 | −1 |
| −30.32 | 0 | −2 |
| −14.22 | 90 | −3 |
| −34 | 0 | −4 |
| −20.05 | 90 | −5 |
| −35.17 | 0 | −6 |
| −23.58 | 90 | −7 |
| −35 | (+/−)180 | −8 |

Example 9 includes a method comprising: driving a plurality of dipole antenna elements of a linear antenna array, wherein the linear antenna array comprises the plurality of dipole antenna elements equally spaced along a central antenna mast such that there are no are no non-fed parasitic elements between any two of the plurality of dipole elements and are oriented normal to the central antenna mast; and wherein driving the plurality of dipole antenna elements further comprises feeding the plurality of dipole antenna elements to a power level and phase that establishes an antenna gain pattern having a signal gain roll-off greater than 30 db occurring between an angle of 90 degrees and 100 degrees from the central antenna mast.

Example 10 includes the method of Example 9, further comprising: supporting the central antenna mast in a position where the mast is oriented substantially normal to the horizon.

Example 11 includes the method of any of Examples 9-10, wherein the plurality of dipole elements are driven such that a dipole element positioned at a center bay along the central antenna mast is driven at 0 db and at a phase angle of 0 degrees, and terminating dipole elements on the central antenna mast are driven at ±180 degrees.

Example 12 includes the method of any of Examples 9-11, wherein dipole elements positioned at even numbered bays along the central antenna mast between the center bay and the terminating dipole element are also driven at a phase angle of 0 degrees.

Example 13 includes the method of any of Examples 9-12, wherein dipole elements positioned at odd numbered bays along the central antenna extending from a first side of the center bay are driven to a phase angle of −90 degrees while dipole elements positioned at odd numbered bays along the central antenna extending from a second side of the center bay are driven to a phase angle of +90 degrees.

Example 14 includes the method of any of Examples 9-13, wherein the plurality of dipole elements comprises a total of seventeen dipole elements.

Example 15 includes the method of Example 14, wherein the seventeen dipole elements are positioned along the central antenna mast in respective antenna bays m=8 to m=−8 and are driven by the feed network to establish a power level and phase in accordance with:

| Power Level | Phase | Bay |
|---|---|---|
| (dB) | (degrees) | (m) |
| −32.4 | (+/−)180 | 8 |
| −24.16 | −90 | 7 |
| −38.82 | 0 | 6 |
| −20.48 | −90 | 5 |
| −34.6 | 0 | 4 |
| −14.68 | −90 | 3 |
| −30.71 | 0 | 2 |
| −4.39 | −90 | 1 |
| 0 | 0 | 0 |
| −4.22 | 90 | −1 |
| −30.32 | 0 | −2 |
| −14.22 | 90 | −3 |
| −34 | 0 | −4 |
| −20.05 | 90 | −5 |
| −35.17 | 0 | −6 |
| −23.58 | 90 | −7 |
| −35 | (+/−)180 | −8 |

Example 16 includes an antenna system, the system comprising: a linear central antenna mast; a plurality of dipole elements equally spaced apart by λ/2 along the linear central antenna mast; and a feed network coupled to the plurality of dipole element; wherein each of the plurality of dipole elements is actively fed by the feed network and wherein there are no non-fed parasitic elements between any two of the plurality of dipole elements.

Example 17 includes the system of Example 16, wherein: the plurality of dipole elements are driven by the feed network to establish a power level and phase to produce an antenna pattern having a signal gain roll-off greater than 30 db occurring between an angle of 90 degrees and 100 degrees from the central antenna mast.

Example 18 includes the system of any of Examples 16-17, wherein the central antenna mast is oriented substantially normal to the horizon such that the plurality of dipole elements are vertically oriented.

Example 19 includes the system of any of Examples 16-18, wherein the plurality of dipole elements comprises a total of seventeen dipole elements.

Example 20 includes the system of Example 19, wherein the seventeen dipole elements are positioned along the central antenna mast in respective antenna bays m=8 to m=−8 and are driven by the feed network to establish a power level and phase in accordance with:

| Power Level | Phase | Bay |
|---|---|---|
| (dB) | (degrees) | (m) |
| −32.4 | (+/−)180 | 8 |
| −24.16 | −90 | 7 |
| −38.82 | 0 | 6 |
| −20.48 | −90 | 5 |
| −34.6 | 0 | 4 |
| −14.68 | −90 | 3 |
| −30.71 | 0 | 2 |
| −4.39 | −90 | 1 |
| 0 | 0 | 0 |
| −4.22 | 90 | −1 |
| −30.32 | 0 | −2 |
| −14.22 | 90 | −3 |
| −34 | 0 | −4 |
| −20.05 | 90 | −5 |
| −35.17 | 0 | −6 |
| −23.58 | 90 | −7 |
| −35 | (+/−)180 | −8 |

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. An antenna system, the system comprising:
a plurality of dipole elements equally spaced along a linear central antenna mast, the plurality of vertically orient dipole elements spaced apart by λ/2 along the central antenna mast and oriented normal to the central antenna mast; and
a feed network to drive each of said elements;
wherein each of the plurality of dipole elements is actively fed by the feed network and wherein there are no non-fed parasitic elements between any two of the plurality of dipole elements.

2. The system of claim 1 wherein the central antenna mast is oriented substantially normal to the horizon such that the plurality of dipole elements are vertically oriented.

3. The system of claim 1, wherein the plurality of dipole elements are driven by the feed network to establish a power level and phase to produce an antenna pattern having a signal gain roll-off greater than 30 db occurring between an angle of 90 degrees and 100 degrees from the central antenna mast.

4. The system of claim 1, wherein the plurality of dipole elements are driven by the feed network such that a dipole element positioned at a center bay along the central antenna mast is driven at 0 db and at a phase angle of 0 degrees, and terminating dipole elements on the central antenna mast are driven at ±180 degrees,

5. The system of claim 4, wherein dipole elements positioned at even numbered bays along the central antenna mast between the center bay and the terminating dipole element are also driven at a phase angle of 0 degrees.

6. The system of claim 5, wherein dipole elements positioned at odd numbered bays along the central antenna extending from a first side of the center bay are driven to a phase angle of −90 degrees while dipole elements positioned at odd numbered bays along the central antenna extending from a second side of the center bay are driven to a phase angle of +90 degrees.

7. The system of claim 1, wherein the plurality of dipole elements comprises a total of seventeen dipole elements.

8. The system of claim 7, wherein the seventeen dipole elements are positioned along the central antenna mast in respective antenna bays m=8 to m=−8 and are driven by the feed network to establish a power level and phase in accordance with:

| Power Level | Phase | Bay |
|---|---|---|
| (dB) | (degrees) | (m) |
| −32.4 | (+/−)180 | 8 |
| −24.16 | −90 | 7 |
| −38.82 | 0 | 6 |
| −20.48 | −90 | 5 |
| −34.6 | 0 | 4 |
| −14.68 | −90 | 3 |
| −30.71 | 0 | 2 |
| −4.39 | −90 | 1 |
| 0 | 0 | 0 |
| −4.22 | 90 | −1 |
| −30.32 | 0 | −2 |
| −14.22 | 90 | −3 |
| −34 | 0 | −4 |
| −20.05 | 90 | −5 |
| −35.17 | 0 | −6 |
| −23.58 | 90 | −7 |
| −35 | (+/−)180 | −8 |

9. A method comprising:
driving a plurality of dipole antenna elements of a linear antenna array, wherein the linear antenna array comprises the plurality of dipole antenna elements equally spaced along a central antenna mast such that there are no are no non-fed parasitic elements between any two of the plurality of dipole elements and are oriented normal to the central antenna mast; and
wherein driving the plurality of dipole antenna elements further comprises feeding the plurality of dipole antenna elements to a power level and phase that establishes an antenna gain pattern having a signal gain roll-off greater than 30 db occurring between an angle of 90 degrees and 100 degrees from the central antenna mast.

10. The method of claim 9, further comprising:
supporting the central antenna mast in a position where the mast is oriented substantially normal to the horizon.

11. The method of claim 9, wherein the plurality of dipole elements are driven such that a dipole element positioned at a center bay along the central antenna mast is driven at 0 db and at a phase angle of 0 degrees, and terminating dipole elements on the central antenna mast are driven at ±180 degrees.

12. The method of claim 11, wherein dipole elements positioned at even numbered bays along the central antenna mast between the center bay and the terminating dipole element are also driven at a phase angle of 0 degrees.

13. The method of claim 12, wherein dipole elements positioned at odd numbered bays along the central antenna extending from a first side of the center bay are driven to a phase angle of −90 degrees while dipole elements positioned at odd numbered bays along the central antenna extending from a second side of the center bay are driven to a phase angle of +90 degrees.

14. The method of claim 9, wherein the plurality of dipole elements comprises a total of seventeen dipole elements.

15. The method of claim 14, wherein the seventeen dipole elements are positioned along the central antenna mast in respective antenna bays m=8 to m=−8 and are driven by the feed network to establish a power level and phase in accordance with:

| Power Level | Phase | Bay |
|---|---|---|
| (dB) | (degrees) | (m) |
| −32.4 | (+/−)180 | 8 |
| −24.16 | −90 | 7 |
| −38.82 | 0 | 6 |
| −20.48 | −90 | 5 |
| −34.6 | 0 | 4 |
| −14.68 | −90 | 3 |
| −30.71 | 0 | 2 |
| −4.39 | −90 | 1 |
| 0 | 0 | 0 |
| −4.22 | 90 | −1 |
| −30.32 | 0 | −2 |
| −14.22 | 90 | −3 |
| −34 | 0 | −4 |
| −20.05 | 90 | −5 |
| −35.17 | 0 | −6 |
| −23.58 | 90 | −7 |
| −35 | (+/−)180 | −8 |

16. An antenna system, the system comprising:
a linear central antenna mast;
a plurality of dipole elements equally spaced apart by λ/2 along the linear central antenna mast; and
a feed network coupled to the plurality of dipole element;
wherein each of the plurality of dipole elements is actively fed by the feed network and wherein there are no non-fed parasitic elements between any two of the plurality of dipole elements.

17. The system of claim 16, wherein:
the plurality of dipole elements are driven by the feed network to establish a power level and phase to produce an antenna pattern having a signal gain roll-off greater than 30 db occurring between an angle of 90 degrees and 100 degrees from the central antenna mast.

18. The system of claim 17, wherein the central antenna mast is oriented substantially normal to the horizon such that the plurality of dipole elements are vertically oriented.

19. The system of claim 16, wherein the plurality of dipole elements comprises a total of seventeen dipole elements.

20. The system of claim 18, wherein the seventeen dipole elements are positioned along the central antenna mast in respective antenna bays m=8 to m=−8 and are driven by the feed network to establish a power level and phase in accordance with:

| Power Level | Phase | Bay |
|---|---|---|
| (dB) | (degrees) | (m) |
| −32.4 | (+/−)180 | 8 |
| −24.16 | −90 | 7 |
| −38.82 | 0 | 6 |
| −20.48 | −90 | 5 |
| −34.6 | 0 | 4 |
| −14.68 | −90 | 3 |
| −30.71 | 0 | 2 |
| −4.39 | −90 | 1 |
| 0 | 0 | 0 |
| −4.22 | 90 | −1 |
| −30.32 | 0 | −2 |
| −14.22 | 90 | −3 |
| −34 | 0 | −4 |
| −20.05 | 90 | −5 |
| −35.17 | 0 | −6 |
| −23.58 | 90 | −7 |
| −35 | (+/−)180 | −8 |
